(19) United States
(12) Patent Application Publication
(10) Pub. No.: US 2025/0273818 A1
(43) Pub. Date: Aug. 28, 2025

(54) METHOD FOR PRODUCING ELECTRODE

(71) Applicant: KABUSHIKI KAISHA TOYOTA JIDOSHOKKI, Kariya-shi, Aichi-ken (JP)

(72) Inventors: Ryota KAMIYA, Kariya-shi (JP); Tomohiro NAKAMURA, Kariya-shi (JP); Takayuki HIROSE, Kariya-shi (JP)

(73) Assignee: KABUSHIKI KAISHA TOYOTA JIDOSHOKKI, Kariya-shi, Aichi-ken (JP)

(21) Appl. No.: 18/857,866

(22) PCT Filed: Apr. 20, 2023
(86) PCT No.: PCT/JP2023/015718

§ 371 Date: Oct. 18, 2024

(30) Foreign Application Priority Data
Apr. 28, 2022 (JP) 2022-074804

(51) Int. Cl. H01M 50/474; H01M 4/70; H01M 10/04

(52) U.S. Cl. CPC H01M 50/474; H01M 4/70; H01M 10/0481

(57) ABSTRACT

A method for producing an electrode is provided. The electrode includes a current collector having a polygonal shape with at least one side exceeding 1 meter, an active material layer provided on a surface of the current collector, and a seal component welded to the surface of the current collector. The method includes a disposing step that disposes the seal component on the surface of the current collector along the side, and a welding step that presses a target section against the current collector and heats the target section. The welding step is performed multiple times between opposite end portions of the seal component. In the second and subsequent welding steps, the target section is a part of the seal component that is at least partially shifted from a target section of the previous welding step.

### TECHNICAL FIELD

The present disclosure relates to a method for producing an electrode.

### BACKGROUND ART

In order to insulate current collectors from each other in a power storage device that includes stacked electrodes, seal components are welded to the current collectors in some cases when the electrodes are produced. For example, in a method for producing an electrode described in Patent Literature 1, seal components are disposed on and welded to a current collector by heating the seal components with a jig while bringing the jig into contact with the seal component.

### CITATION LIST

### Patent Literature

Patent Literature 1: Japanese Laid-Open Patent Publication No. 2018-106963

### SUMMARY OF INVENTION

### Technical Problem

In a case in which seal components made of plastic are welded to a current collector, thermal shrinkage occurs in parts of the seal components welded to the current collector. At this time, the larger the parts of the seal components welded to the current collector, the larger the amount of thermal shrinkage of the seal components becomes. As the amount of thermal shrinkage of the seal components increases, the shrinkage force transmitted to the current collector due to the thermal shrinkage of the seal components increases. Accordingly, the current collector is likely to be deformed.

### Solution to Problem

In one aspect of the present disclosure, a method for producing an electrode is provided. The electrode includes a current collector having a polygonal shape with at least one side exceeding 1 meter in plan view, an active material layer provided on a surface of the current collector, and at least one seal component welded to the surface of the current collector. The method includes: a disposing step that disposes the seal component on the surface of the current collector along the side; and a welding step that presses a target section of the seal component against the current collector and heats the target section while causing a jig to be in planar contact with the target section, thereby forming a welding part in which the target section is welded to the surface of the current collector, a dimension of the target section in a direction in which the side extends being smaller than the side. The welding step is performed multiple times between opposite end portions of the seal component in the extending direction of the side. In the second and subsequent welding steps, the target section is a part of the seal component that is at least partially shifted from a target section of the previous welding step in the extending direction of the side.

According to the above-described method, the seal component includes the target section, and the dimension of the target section in the extending direction of the side is smaller than the side. The welding step is executed to press the target section against the current collector and heats the target section with the jig while causing the jig to be in planar contact with the target section, thereby forming the welding part, in which the target section is welded to the surface of the current collector. Therefore, as compared to a case in which the dimension of the target section in the extending direction of the side is the same as the dimension of the side, the dimension of the target section is reduced. The amount of thermal expansion of the seal component is reduced, accordingly. As the amount of thermal expansion of the seal component decreases, the amount of thermal shrinkage of the seal component decreases. This reduces the shrinkage force transmitted from the seal component to the current collector due to thermal shrinkage of the seal component. Accordingly, the deformation of the current collector that occurs when the seal component is welded to the current collector is reduced.

In the method for producing the electrode, in the disposing step, the seal component may be disposed on each of opposite surfaces of the current collector. The welding step may be performed on the seal components disposed on the opposite surfaces of the current collector.

In the disposing step of the above-described method, the seal component is disposed on each of the opposite surfaces of the current collector. The welding step is performed on the seal components disposed on the opposite surfaces of the current collector. This reduces deformation of the current collector that occurs when the seal components are welded to the opposite surfaces of the current collector.

In the method for producing the electrode, in the second or subsequent welding steps, a part of the target section in the extending direction of the side may overlap with the target section of the previous welding step.

According to the above-described method, in the second and subsequent welding steps, a part of the target section in the extending direction of the side overlaps with the target section of the previous welding step. Therefore, when the welding step is performed, even if the relative position of the target section with respect to the jig in the extending direction of the side is displaced from the intended position, only the extent of overlap between the target section and the target section of the previous welding step will change with respect to the extending direction of the side. Accordingly, the multiple target sections are unlikely to have parts that are not welded to the current collector. This reduces the occurrence of welding defects in the seal components to the current collector.

In the method for producing the electrode, the jig may include a heater portion that heats the target section while being in planar contact with the target section, and a corner portion that is located at a periphery of the heater portion and comes into contact with the seal component when the target section is heated by the heater portion. The corner portion may be curved.

According to the above-described method, the jig includes the corner portion that comes into contact with the seal component when the target section is heated by the heater portion. Since the corner portion is curved, it is possible to reduce the occurrence of local bulging of the seal component due to the seal component being pressed by the corner portion when the corner portion comes into contact with the seal component.

In the method for producing the electrode, a dimension of the target section in the extending direction of the side may be less than or equal to 720 mm.

According to the above-described method, the dimension of the target section in the extending direction of the side is less than or equal to the 720 mm. This further reduces deformation of the current collector that occurs when the seal component is welded to the current collector.

### Advantageous Effects of Invention

The present invention reduces deformation of the current collector that occurs when the seal component is welded to the current collector.

### BRIEF DESCRIPTION OF DRAWINGS

FIG. 1 is a cross-sectional view of a power storage device according to an embodiment.

FIG. 2 is an enlarged partial cross-sectional view of the power storage device shown in FIG. 1.

FIG. 3 is a top view of an electrode included in the power storage device shown in FIG. 1.

FIG. 4 is a cross-sectional view for explaining a welding step for a first target section in a method for producing an electrode according to the embodiment.

FIG. 5 is a cross-sectional view taken along line 5-5 of FIG. 4.

FIG. 6 is a cross-sectional view taken along line 6-6 of FIG. 4.

FIG. 7 is a cross-sectional view for explaining a welding step for a second target section in the method for producing the electrode according to the embodiment.

FIG. 8 is a cross-sectional view for explaining a welding step for a third target section in the method for producing the electrode according to the embodiment.

FIG. 9 is a cross-sectional view for explaining formation of a sealing portion in the method for producing the electrode according to the embodiment.

### DESCRIPTION OF EMBODIMENTS

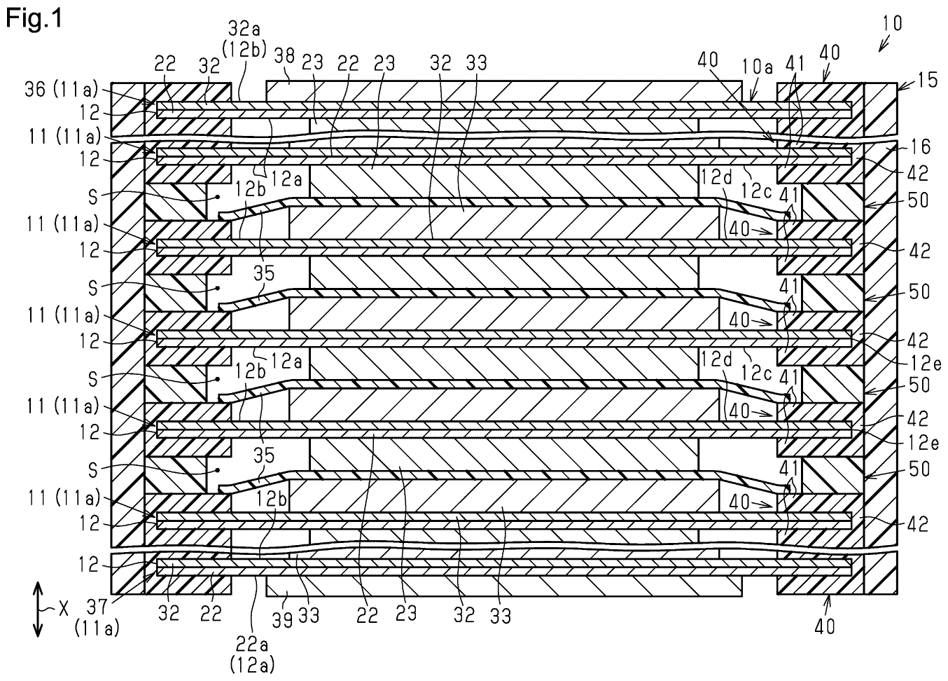

A method for producing an electrode according to an embodiment will now be described with reference to FIGS. 1 to 9. For ease of explanation, a power storage device and an electrode will be described below before the method for producing the electrode.

### Power Storage Device

As shown in FIG. 1, a power storage device 10 includes a stacked body 10a and a sealing body 15. The stacked body 10a is formed by stacking multiple electrodes 11 between a positive terminal electrode 36 and a negative terminal electrode 37. The power storage device 10 is, for example, a lithium-ion rechargeable battery. Hereinafter, the stacking direction of the electrodes 11 will be simply referred to as a stacking direction X.

### Electrodes

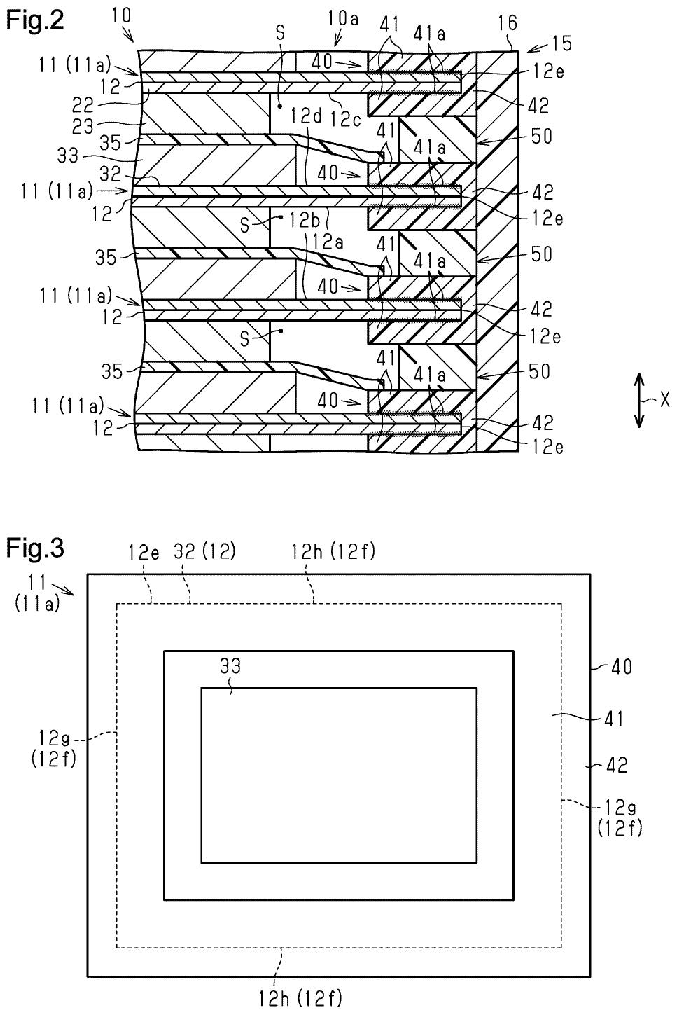

As shown in FIGS. 1 and 2, each of the multiple electrodes 11 includes a current collector 12, a positive electrode active material layer 23, and a negative electrode active material layer 33. The current collector 12 is a sheet. The current collector 12 includes a first surface 12a and a second surface 12b, which are opposite to each other in the stacking direction X. The positive electrode active material layer 23 is provided on the first surface 12a of the current collector 12, and the negative electrode active material layer 33 is provided on the second surface 12b. Each of the multiple electrodes 11 is a bipolar electrode. In the stacked body 10a, the electrodes 11 are stacked such that the first surface 12a of the current collector 12 of one of any two electrodes 11 adjacent to each other in the stacking direction X faces the second surface 12b of the current collector 12 of the other of the two electrodes 11 with the separators 35 interposed therebetween. In other words, the electrodes 11 are stacked such that the positive electrode active material layer 23 of one of any two electrodes 11 adjacent to each other in the stacking direction X faces the negative electrode active material layer 33 of the other electrode 11 with the separator 35 interposed therebetween.

In plan view in the stacking direction X (hereinafter, simply referred to as plan view), the positive electrode active material layer 23 is formed in a central portion of the first surface 12a of each current collector 12. A peripheral portion of the first surface 12a of the current collector 12 in plan view is a positive electrode uncoated portion 12c, on which the positive electrode active material layer 23 is not provided. The positive electrode uncoated portion 12c is disposed to surround the positive electrode active material layer 23 in plan view. In plan view, the negative electrode active material layer 33 is formed in a central portion of the of the second surface 12b of each current collector 12. A peripheral portion of the second surface 12b of the current collector 12 in plan view is a negative electrode uncoated portion 12d, on which the negative electrode active material layer 33 is not provided. The negative electrode uncoated portion 12d is disposed to surround the negative electrode active material layer 33 in plan view.

Each positive electrode active material layer 23 and the corresponding negative electrode active material layer 33 are disposed to face each other in the stacking direction X. For example, the negative electrode active material layers 33 are formed to be slightly larger than the positive electrode active material layers 23. In plan view, the entire formation region of each positive electrode active material layer 23 is located within the formation region of each negative electrode active material layer 33.

### Details of Current Collectors

In the present embodiment, each current collector 12 is formed by integrating a sheet-shaped positive electrode current collector 22 and a sheet-shaped negative electrode current collector 32. The first surface 12a of each current collector 12 is formed by one surface of the positive electrode current collector 22, and the second surface 12b is formed by one surface of the negative electrode current collector 32. The positive electrode current collector 22 and the negative electrode current collector 32 may be integrated by bonding the surface of the positive electrode current collector 22 that is on the side opposite to the first surface 12a to the surface of the negative electrode current collector 32 that is on the side opposite to the second surface 12b. The positive electrode current collector 22 and the negative electrode current collector 32 have the same shape in plan view.

As shown in FIG. 3, each current collector 12 has a polygonal shape having multiple (three or more) sides 12f in plan view. Specifically, each current collector 12 has four sides 12f and a rectangular shape in plan view. An outer edge 12e of the current collector 12 is formed by the four sides 12f. In some cases, two of the sides 12f are also referred to as short sides 12g, and the two sides 12f longer than the short sides 12g are also referred to as long sides 12h. The short sides 12g and the long sides 12h are longer than 1 meter. The short sides 12g are, for example, 1.2 meters. The long sides 12h are, for example, 1.5 meters.

As shown in FIG. 1, the positive electrode current collectors 22 and the negative electrode current collectors 32 are chemically inert electric conductors for allowing current to continuously flow through the positive electrode active material layers 23 and the negative electrode active material layers 33 during discharging or charging of the lithium-ion rechargeable battery. The positive electrode current collectors 22 and the negative electrode current collectors 32 may be made of, for example, a metal, a conductive plastic, or a conductive inorganic material.

The conductive plastic may be a plastic obtained by adding a conductive filler to a conductive polymer material or a non-conductive polymer material, as necessary. The positive electrode current collectors 22 and the negative electrode current collectors 32 may each include one or more layers containing a metal or a conductive plastic. The surfaces of the positive electrode current collectors 22 and the negative electrode current collectors 32 may be covered with a known protective layer. The surfaces of the positive electrode current collectors 22 and the negative electrode current collectors 32 may be plated with a metal by a known method such as a plating treatment.

The positive electrode current collectors 22 and the negative electrode current collectors 32 may include, for example, foils, sheets, films, wires, rods, meshes, or clad materials. In a case in which the positive electrode current collectors 22 and the negative electrode current collectors 32 are metal foils, the positive electrode current collectors 22 and the negative electrode current collectors 32 may be, for example, aluminum foils, copper foils, nickel foils, titanium foils, or stainless steel foils. The positive electrode current collectors 22 and the negative electrode current collectors 32 may be alloy foils of any of the above-mentioned metals. When the positive electrode current collectors 22 and the negative electrode current collectors 32 are metal foils, the thicknesses of each positive electrode current collector 22 and each negative electrode current collector 32 are, for example, in a range of 1 μm to 100 μm. The positive electrode current collectors 22 of the present embodiment are aluminum foils. The negative electrode current collectors 32 of the present embodiment are copper foils. In order to stabilize the structure of the stacked body 10a, for example, the current collectors 12 of the positive terminal electrode 36 and the negative terminal electrode 37 and/or some of the current collectors 12 of the electrodes 11, which are formed of bipolar electrodes, may have a thickness greater than or equal to 100 μm.

The current collectors 12 are not limited to a form in which the positive electrode current collector 22 and the negative electrode current collector 32 are integrated. For example, each current collector 12 may be a single current collector sheet formed of a metal, a conductive plastic, or a conductive inorganic material. Alternatively, the current collector 12 may be a single current collector sheet in which a coating layer is formed by plating the surface of the current collector sheet. In these cases, one current collector 12 is used as the positive electrode current collector 22 and the negative electrode current collector 32.

### Details of Positive Electrode Active Material Layers and Negative Electrode Active Material Layers

Each positive electrode active material layer 23 includes a positive electrode active material capable of storing and releasing lithium ions as charge carriers. The positive electrode active material may be, for example, a polyanionic compound such as olivine-type lithium iron phosphate (LiFePO₄), lithium composite metallic oxides having a layered rock-salt structure, or spinel-structure metal oxides. The positive electrode active material may be any material as long as it can be used as the positive electrode active material of the power storage device 10 such as a lithium-ion rechargeable battery.

Each negative electrode active material layer 33 includes a negative electrode active material capable of storing and releasing charge carriers such as lithium ions. The negative electrode active material is not particularly limited as long as it is a simple substance, an alloy, or a compound capable of storing and releasing charge carriers such as lithium ions. For example, the negative electrode active material may be Li or an element that can be alloyed with carbon, a metal compound, or lithium, or a compound thereof. The carbon may be, for example, natural graphite, artificial graphite, hard carbon (non-graphitizable carbon), or soft carbon (graphitizable carbon). The artificial graphite may be, for example, highly oriented graphite or mesocarbon microbeads. Elements that can be alloyed with lithium may be silicon or tin.

The positive electrode active material layer 23 and the negative electrode active material layer 33 may contain, as necessary, a component for enhancing electric conductivity, for example, a conductive aid, a binder, an electrolyte (for example, a polymer matrix, an ion conductive polymer, or a liquid electrolyte), or an electrolyte-supporting salt (lithium salt) for enhancing ion conductivity. The types and compound ratios of these components contained in the positive electrode active material layer 23 and the negative electrode active material layer 33 are not particularly limited.

The conductive aid may be, for example, acetylene black, carbon black, or graphite. The binder may be, for example, a fluorine-containing resin such as polyvinylidene fluoride, polytetrafluoroethylene, or fluororubber, a thermoplastic resin such as polypropylene or polyethylene, an imide-based resin such as polyimide or polyamide-imide, an alkoxysilyl group-containing resin, an acrylic resin such as poly (meth) acrylic acid, styrene-butadiene rubber, carboxymethyl cellulose, an alginate such as sodium alginate or ammonium alginate, a water-soluble cellulose ester crosslinked product, or a starch-acrylic acid graft polymer. These binders may be used alone or in combination. As the solvent or dispersion medium, for example, water or N-methyl-2-pyrrolidone is used.

### Separators

The power storage device 10 includes multiple separators 35. Each separator 35 is disposed between a positive electrode active material layer 23 and a negative electrode active material layer 33. The separator 35 separates the positive electrode active material layer 23 and the negative electrode active material layer 33 from each other to prevent short circuits due to contact between electrodes and allows charge carriers such as lithium ions to pass therethrough.

The separators 35 are, for example, porous sheets or nonwoven fabric containing a polymer that absorbs and retains electrolyte. The electrolyte with which the separators 35 are impregnated may be a liquid electrolyte containing a nonaqueous solvent and an electrolyte salt dissolved in the nonaqueous solvent, or a polymer gel electrolyte containing an electrolyte held in a polymer matrix. In the present embodiment, a liquid electrolyte is used as the electrolyte. As the electrolyte salt in the liquid electrolyte, for example LiClO₄, LiAsF₆, LiPF₆, LiBF₄, LiCF₃SO₃, LiN(FSO₂)₂, or LiN(CF₃SO₂)₂ may be used. Alternatively, other known lithium salts may be used. As the nonaqueous solvent, for example, cyclic carbonates, cyclic esters, chain carbonates, chain esters, or ethers may be used. Alternatively, other known solvents may be used. These known solvent materials may be used in a combination of two or more thereof. The material of the separators 35 may be, for example, polypropylene, polyethylene, polyolefin, or polyester. The separators 35 may have a single-layer structure or a multilayer structure. The multilayer structure may include, for example, at least one of an adhesive layer and a ceramic layer, which is a heat-resistant layer.

### Positive Terminal Electrodes and Negative Terminal Electrodes

In the stacking direction X, the multiple electrodes 11 are each located between a positive terminal electrode 36 and a negative terminal electrode 37. The positive terminal electrode 36 includes a current collector 12 and a positive electrode active material layer 23 disposed on the first surface 12a of the current collector 12. The positive terminal electrode 36 has the same configuration as the electrode 11 except that it does not include a negative electrode active material layer 33. The negative terminal electrode 37 includes a current collector 12 and a negative electrode active material layer 33 disposed on the second surface 12b of the current collector 12. The negative terminal electrode 37 has the same configuration as the electrode 11 except that it does not include a positive electrode active material layer 23. The current collector 12 of the positive terminal electrode 36 is located at a first end in the stacking direction X of the stacked body 10a. The current collector 12 of the negative terminal electrode 37 is located at a second end in the stacking direction X of the stacked body 10a.

The second surface 12b of the current collector 12 included in the positive terminal electrode 36 is a first outer surface 32a of the stacked body 10a. The first outer surface 32a is a first end face in the stacking direction X of the stacked body 10a. The first surface 12a of the current collector 12 included in the negative terminal electrode 37 is a second outer surface 22a of the stacked body 10a. The second outer surface 22a is a second end face in the stacking direction X of the stacked body 10a. The first outer surface 32a and the second outer surface 22a are flat surfaces extending to be orthogonal to the stacking direction X.

### Internal Spaces

Between any two of the current collectors 12 adjacent to each other in the stacking direction X, one internal space S exists for each pair of the positive electrode current collector 22 and the negative electrode current collector 32 adjacent to each other in the stacking direction X. Each internal space S is defined by a positive electrode current collector 22 and a negative electrode current collector 32 that are adjacent to each other in the stacking direction X, and the sealing body 15. Each internal space S accommodates a positive electrode active material layer 23, a negative electrode active material layer 33, a separator 35, and liquid electrolyte (not shown). Examples of the liquid electrolyte include an electrolyte solution containing a nonaqueous solvent and an electrolyte salt dissolved in the nonaqueous solvent.

### Positive Electrode Energization Plate and Negative Electrode Energization Plate

The power storage device 10 includes a positive electrode energization plate 38 and a negative electrode energization plate 39. The positive electrode energization plate 38 and the negative electrode energization plate 39 are formed of a material having a good conductivity. The material forming the positive electrode energization plate 38 and the negative electrode energization plate 39, may be, for example, aluminum, copper, stainless steel, or other metals. The stacked body 10a is disposed between the positive electrode energization plate 38 and the negative electrode energization plate 39 in the stacking direction X.

The positive electrode energization plate 38 is electrically connected to the first outer surface 32a of the stacked body 10a. The negative electrode energization plate 39 is electrically connected to the second outer surface 22a of the stacked body 10a. Each of the positive electrode energization plate 38 and the negative electrode energization plate 39 is provided with a terminal (not shown). The power storage device 10 performs charging and discharging through the terminals provided on the positive electrode energization plate 38 and the negative electrode energization plate 39.

### Sealing Body

The sealing body 15 is disposed to surround the multiple electrodes 11, the positive electrode active material layer 23 of the positive terminal electrode 36, and the negative electrode active material layer 33 of the negative terminal electrode 37 when viewed in the stacking direction X. Hereinafter, the electrodes 11, the positive terminal electrode 36, and the negative terminal electrode 37 may be simply referred to as electrodes 11a. The sealing body 15 provides a seal between any two of the current collectors 12 that are adjacent to each other in the stacking direction X.

As shown in FIGS. 2 and 3, the sealing body 15 includes multiple seal members 40 welded to the respective current collectors 12 of the electrodes 11a. The seal members 40 are made of plastic. Each of the seal members 40 includes two first seal sections 41 and a second seal section 42. The first seal sections 41 are each disposed between the first surface 12a of the current collector 12 of one of two electrodes 11a adjacent to each other in the stacking direction X and the second surface 12b of the current collector 12 of the other electrode 11a. In other words, the first seal sections 41 are disposed inside the outer edges 12e of the current collectors 12 when viewed in the stacking direction X.

The two first seal sections 41 are disposed on the opposite surfaces (the first surface 12a and the second surface 12b) of the current collector 12. The first seal sections 41 are disposed continuously along the four sides 12f. In other words, the seal member 40 includes two first seal sections 41 disposed on the opposite surfaces of the current collector 12 along the sides 12f.

Each seal member 40 includes a welding part 41a at which the seal member 40 is welded to the corresponding current collector 12. The welding part 41a is located at the boundary between the first surface 12a and the second surface 12b in each first seal section 41. The first seal sections 41 are respectively welded to the positive electrode uncoated portions 12c and the negative electrode uncoated portions 12d at the welding parts 41a. Thus, each seal member 40 is welded to the first surface 12a and the second surface 12b of the current collector 12 of the corresponding electrode 11a via the welding parts 41a. The first seal sections 41 located on the positive electrode uncoated portions 12c are disposed to surround the positive electrode active material layers 23. The first seal sections 41 located on the negative electrode uncoated portions 12d are disposed to surround the negative electrode active material layers 33. Each first seal section 41 has the shape of a rectangular frame. In other words, the rectangular frame-shaped first seal section 41 is a member having a specified width that continuously surrounds the periphery of the positive electrode active material or the negative electrode active material in plan view.

The second seal sections 42 extend outward beyond the outer edges 12e of the current collectors 12 from the first seal sections 41. Specifically, the second seal sections 42 are located on the outer side of the outer edges 12e of the current collectors 12 when viewed in the stacking direction X. The second seal sections 42 are disposed to surround the current collectors 12 when viewed in the stacking direction X. Each second seal section 42 has the shape of a rectangular frame. Each second seal section 42 covers an end face connecting the first surface 12a and the second surface 12b of the corresponding current collector 12. Each second seal section 42 also connects the outer periphery of the first seal section 41 located on the corresponding positive electrode uncoated portion 12c to the outer periphery of the first seal section 41 located on the corresponding negative electrode uncoated portion 12d.

As shown in FIG. 2, the sealing body 15 includes multiple spacers 50. Each spacer 50 is adjacent to the corresponding first seal sections 41 and the corresponding second seal section 42 in the stacking direction X. Each spacer 50 is located between the seal members 40 provided on two of the electrodes 11 adjacent to each other in the stacking direction X. The spacers 50 are disposed to surround the positive electrode active material layers 23 and the negative electrode active material layers 33. Each spacer 50 has the shape of a rectangular frame. The spacers 50 are made of plastic.

The spacers 50 are not welded to the first seal sections 41. Therefore, the spacers 50 are not welded to the current collectors 12. The opposite surfaces of each spacer 50 in the stacking direction X may contact or be separate from the corresponding first seal sections 41.

Each set of the first seal sections 41 and the corresponding spacer 50 is located between two of the current collectors 12 that are adjacent to each other in the stacking direction X. Thus, each set of the first seal sections 41 and the corresponding spacer 50 maintains the distance between the positive electrode current collector 22 of one of the two current collectors 12 adjacent to each other in the stacking direction X and the negative electrode current collector 32 of the other current collector 12, so as to insulate the positive electrode current collector 22 and the negative electrode current collector 32 from each other. In this manner, the seal members 40 and the spacers 50 prevent the occurrence of short circuits between each positive electrode current collector 22 and the corresponding negative electrode current collector 32.

Each spacer 50 is welded to at least parts of the corresponding second seal sections 42 adjacent to the spacer 50 in the stacking direction X. Thus, the seal members 40 are integrated with the spacers 50. Regions on each spacer 50 that has a specified width from the outer edge is welded to regions of the corresponding second seal sections 42 that have the specified width from the outer edges.

The sealing body 15 has a sealing portion 16, which includes the spacers 50 and the second seal sections 42, which are welded together. In the sealing portion 16, the spacers 50 and the second seal sections 42 are compatibilized. The sealing portion 16 has a tubular shape extending in the stacking direction X. The sealing portion 16 surrounds the current collectors 12 from the outside of the stacked body 10a.

The sealing portion 16 seals the internal spaces S each located between two of the current collectors 12 adjacent to each other in the stacking direction X. The sealing portion 16 prevents water from entering the internal spaces S from the outside of the power storage device 10. The sealing portion 16 prevents leakage of the liquid electrolyte accommodated in the internal spaces S to the outside of the power storage device 10.

### Method for Producing Electrode

Next, a method for producing the electrodes 11a will be described. Although the following description will be made using the electrode 11, the positive terminal electrode 36 and the negative terminal electrode 37 are produced in the same manner.

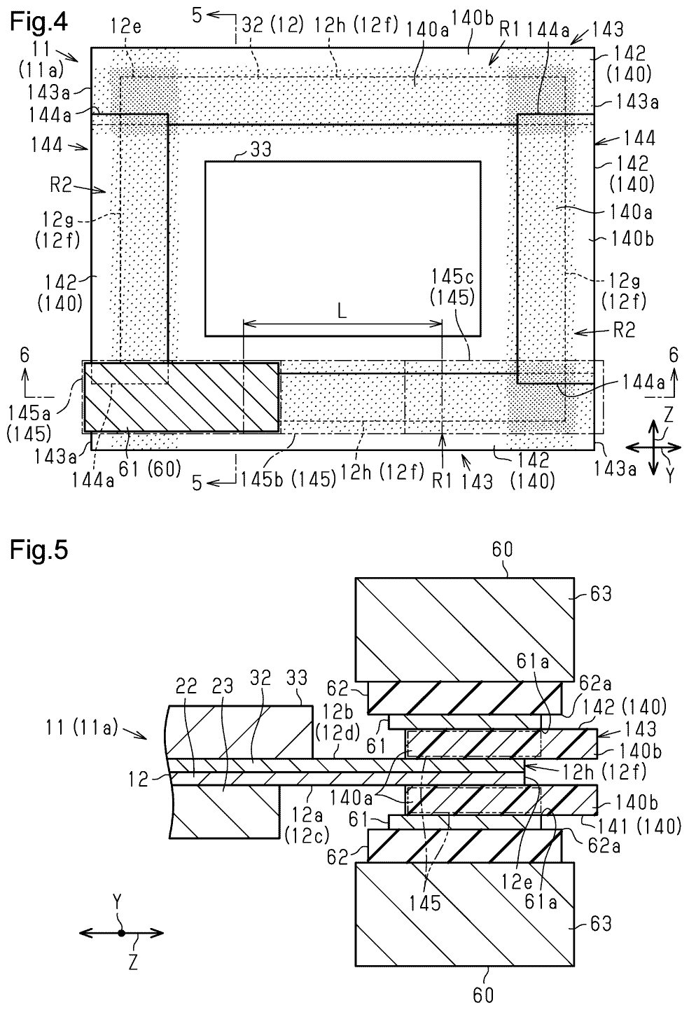

As shown in FIGS. 4 and 5, the electrode 11 is produced by welding the seal components 140 to the current collector 12 using jigs 60. Specifically, a positive electrode active material layer 23 is disposed on the first surface 12a of the current collector 12, and a negative electrode active material layer 33 is disposed on the second surface 12b. That is, the seal components 140 are welded to the current collector 12, which has active material layers disposed on the opposite surfaces. The produced electrode 11 includes the current collector 12, the active material layers provided on the surfaces of the current collector 12, and the seal components 140 welded to the surfaces of the current collector 12.

### Disposing Step

Prior to welding the seal components 140 to the current collector 12, the seal components 140 are disposed on the current collector 12 (disposing step). The seal components 140 are made of plastic. In the disposing step, separate seal components 140 (a first seal component 141 and a second seal component 142) are disposed on the opposite surfaces of the current collector 12, that is, on the first surface 12a and the second surface 12b, respectively. When the seal components 140 are disposed so as to extend along the sides 12f of the current collector 12, the seal components 140 may be temporarily fixed (temporarily welded) to the current collector 12 by performing spot welding (point welding) with ultrasonic waves or heat.

As shown in FIG. 5, in the disposing step, the seal component 140 disposed on the first surface 12a is the first seal component 141. The first seal component 141 is separated from the positive electrode active material layer 23. In the disposing step, the seal component 140 disposed on the second surface 12b is the second seal component 142. The second seal component 142 is separated from the negative electrode active material layer 33. The current collector 12 is sandwiched from the opposite sides in the thickness direction of the current collector 12 by the first seal component 141 and the second seal component 142.

Each seal component 140 includes a protruding portion 140b that protrudes from the outer edge 12e of the current collector 12. The protruding portion 140b is a portion that does not overlap with the current collector 12 when viewed in the direction in which the current collector 12 and the seal components 140 are stacked. The protruding portion 140b of the first seal component 141 and the protruding portion 140b of the second seal component 142 are separated from each other. Parts of the seal components 140 that are disposed on the opposite surfaces of the current collector 12 are referred to as main bodies 140a. The main bodies 140a are parts that overlap with the current collector 12 when viewed in the direction in which the current collector 12 and the seal components 140 are stacked. Each of the first seal component 141 and the second seal component 142 includes a main body 140a and a protruding portion 140b. The protruding portions 140b of the first seal component 141 and the second seal component 142 each extend from the corresponding main body 140a. In other words, each seal component 140 is disposed on the current collector 12 so as to have both a part overlapping with the current collector 12 and a part not overlapping with the current collector 12 when viewed in the direction in which the current collector 12 and the seal components 140 are stacked.

As shown in FIG. 4, in the disposing step, two of the seal components 140 are disposed on the opposite surfaces of the current collector 12 along each side 12f of the current collector 12. Each of the seal components 140 has the shape of a strip and extends in a longitudinal direction along the side 12f on which the seal component 140 is disposed, so that a direction intersecting that side 12f is a transverse direction (width direction) of the seal component 140. Specifically, the seal components 140 are respectively disposed so as to extend along the two long sides 12h and the two short sides 12g of the current collector 12. In the disposing step, separate seal components 140 are disposed on any adjacent two of the sides 12f. The seal components 140 disposed along each short side 12g are also referred to as short-side seal components 144. The seal components 140 disposed along each long side 12h are also referred to as long-side seal components 143. The long-side seal components 143 and the short-side seal components 144 respectively include a first seal component 141 and a second seal component 142. The direction in which the long sides 12h extend is also referred to as a first direction Y. The direction in which the short sides 12g extend is also referred to as a second direction Z. The first direction Y is a direction in which two of the four sides 12f extend, and the second direction Z is a direction in which the remaining two of the four sides 12f extend.

When viewed in the direction in which the current collector 12 and the seal components 140 are stacked, opposite end portions 143a of each long-side seal component 143 in the first direction Y protrude further outward from the current collector 12 than the outer edges 12e of the opposite ends of the current collector 12 in the first direction Y. Each of the long-side seal components 143 overlaps with one long side 12h of the current collector 12 and end portions in the second direction Z of the two short sides 12g of the current collector 12.

The short-side seal components 144 extend between the two long-side seal components 143 in the second direction Z. The short-side seal components 144 may overlap with the long-side seal components 143, or may be disposed between the two long-side seal components 143 so as not to overlap with the long-side seal components 143. In the present embodiment, each short-side seal component 144 overlaps with parts of the opposite end portions of the corresponding short side 12g of the current collector 12 with which the long-side seal components 143 overlap. In other words, the short-side seal components 144 and the long-side seal components 143 overlap with each other.

The long-side seal components 143 and the short-side seal components 144 are disposed to form a frame on each of the first surface 12a and the second surface 12b. The positive electrode active material layer 23 is surrounded by the long-side seal components 143 and the short-side seal components 144 that are the first seal components 141. The negative electrode active material layer 33 is surrounded by the long-side seal components 143 and the short-side seal components 144 that are the second seal components 142.

### Jigs

As shown in FIG. 5, jigs 60 used for welding the seal components 140 to the current collector 12 are, for example, impulse sealers having a heating wire. The impulse sealers include two jigs 60 disposed so as to sandwich the current collector 12 in the thickness direction (direction orthogonal to the first direction Y and the second direction Z).

Each jig 60 includes a heater portion 61. The heater portion 61 is, for example, a metal plate that incorporates a heating wire (not shown). By adjusting the amount of current flowing through the heating wire, it is possible to switch the heater portion 61 between heating and stopping the heating. The shape of each heater portion 61 can be changed.

Each jig 60 includes a rubber portion 62 and a base portion 63. The rubber portion 62 is made of, for example, silicone rubber. The rubber portion 62 is positioned to overlap with the heater portion 61 in the thickness direction of the current collector 12. The heater portion 61 is fixed to the rubber portion 62. The rubber portion 62 is compressively deformable.

The base portion 63 is made of, for example, metal. The rubber portion 62 is located between the base portion 63 and the heater portion 61. Thus, the rubber portion 62 insulates the base portion 63 and the heater portion 61 from each other. The rubber portion 62 suppresses heat transfer from the heater portion 61 to the base portion 63. The rubber portion 62 is fixed to the base portion 63. Thus, the heater portion 61, the rubber portion 62, and the base portion 63 are integrated with each other. The base portion 63 is movable with respect to the welding targets. For example, an operator operates an operation device (not shown) to change the position of the base portion 63 with respect to a seal component and a current collector foil, which are welding targets. When the position of the base portion 63 with respect to the welding targets is changed, the heater portion 61 and the rubber portion 62, which are integrated with the base portion 63, are moved integrally with the base portion 63.

The heater portion 61 and the rubber portion 62 have the shape of a rectangular flat plate. The longitudinal direction of the heater portion 61 and the rubber portion 62 is also referred to as the longitudinal direction of the jig 60. The transverse direction of the heater portion 61 and the rubber portion 62 is also referred to as the transverse direction of the jig 60.

The dimension of the rubber portion 62 in the transverse direction of the jig 60 is greater than the dimension of the heater portion 61 in the transverse direction of the jig 60. The rubber portion 62 has a rubber protruding portion 62a that protrudes outward from an end portion 61a of the heater portion 61 in the transverse direction of the jig 60 when viewed in the stacking direction, in which the heater portion 61 and the rubber portion 62 overlap with each other.

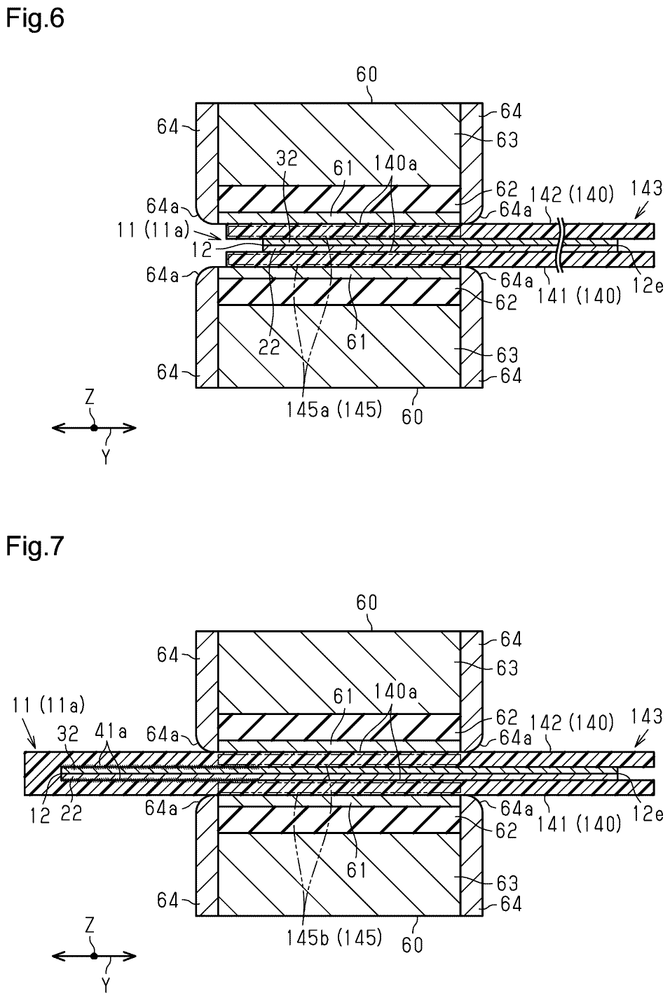

As shown in FIG. 6, each jig 60 includes jig electrodes 64. The jig electrodes 64 are located outward of the opposite ends of each of the heater portion 61, the rubber portion 62, and the base portion 63 in the longitudinal direction of the jig 60. Each jig electrode 64 has a corner portion 64a. The corner portions 64a are curved. The contact surface of the heater portion 61 with the corresponding seal component 140 and the surfaces of the jig electrodes 64, which are orthogonal to the longitudinal direction of the jig 60, are smoothly connected to each other via the corner portions 64a. The corner portions 64a are adjacent to the heater portion 61 in the longitudinal direction of the jig 60. In other words, the corner portions 64a are located at the periphery of the heater portion 61. Each jig 60 includes the corner portions 64a.

### Welding Step

As shown in FIG. 4, after the disposing step, the seal components 140 are welded to the current collector 12 by using the jigs 60 (welding step). In the welding step, the jigs 60 are brought into planar contact with target sections 145, which are parts of the seal components 140, and the target sections 145 are heated by the jigs 60 while being pressed against the current collector 12. Specifically, the target section 145 of each seal component 140 is a part between the opposite ends of the seal component 140 in the direction in which the corresponding side 12f extend. The dimension of each target section 145 in the direction in which the side 12f extends is smaller than the dimension of the side 12f of the current collector 12. The heater portions 61 are brought into planar contact with the target sections 145, and the target sections 145 are heated by the heater portions 61 while being pressed against the current collector 12. Thus, in the welding step, the target sections 145 are welded to the surfaces of the current collector 12. The sizes of the target sections 145 are the same as the size of regions where the heater portions 61 are in contact with and face the seal components 140. In the welding step, a sheet 65 may be disposed between the heating surface of each heater portion 61 and the set of the current collector 12 and the corresponding seal component 140. The heater portion 61 may be pressed against the current collector 12 and the seal component 140 via the sheet 65 to heat the seal component 140. This prevents the melted seal component 140 from adhering to the heating surface of the heater portion 61.

The sheet 65 may be, for example, obtained by coating the surfaces of a base sheet with a fluoropolymer having heat resistance, non-stick property, and slipperiness. The sheet 65 may be, for example, formed by impregnating heat-resistant base sheets with a fluorine compound such as polytetrafluoroethylene.

As shown in FIG. 5, each target section 145 includes the main body 140a and part of the protruding portion 140b. Therefore, in the welding step, the main bodies 140a are welded to the surfaces of the current collector 12. Also, parts of the protruding portions 140b of the first seal component 141 and the second seal component 142 are welded to each other.

As shown in FIG. 4, in the welding step, the seal components 140 are welded to the current collector 12 while changing the relative position of the electrode 11 with respect to the jigs 60 in the direction in which the sides 12f of the current collector 12 extend. Specifically, the welding of the long-side seal components 143 to the current collector 12 is performed while changing the relative position of the electrode 11 with respect to the jigs 60 in the first direction Y. The welding of the short-side seal components 144 to the current collector 12 is performed while changing the relative positions of the electrode 11 with respect to the jigs 60 in the second direction Z. In the present embodiment, the relative position of the electrode 11 with respect to the jigs 60 is changed by moving the electrode 11 in the first direction Y by a moving device (transfer device) such as a belt conveyor or a robot hand.

The dimension of each target section 145 in the direction in which the sides 12f extend is also referred to as a dimension L of the target section 145. In the welding step performed on the long-side seal components 143, the dimension L of the target sections 145 is the dimension of the target sections 145 in the first direction Y. In the welding step performed on the short-side seal components 144, the dimension L of the target sections 145 is the dimension of the target sections 145 in the second direction Z. When the welding step is performed on the long-side seal components 143, the dimension L of the target sections 145 is smaller than that of the long sides 12h. Although not shown in FIG. 4, when the welding step is performed on the short-side seal components 144, the dimension L of the target sections 145 is smaller than that of the short sides 12g. The upper limit of the dimension L may be less than or equal to one half of the length of each long side 12h (1.5 meters). Further, the lower limit of the dimension L may be greater than or equal to one third of each long side 12h in order to limit the number of times of performing the welding step. In the present embodiment, the dimension L of each target section 145 is less than or equal to the 720 mm both when the welding step is performed on the long-side seal components 143 and when the welding step is performed on the short-side seal components 144.

A region where the heater portions 61 are located when the long-side seal components 143 are welded to the current collector 12 is referred to as a long-side region R1. A region where the heater portions 61 are located when the short-side seal components 144 are welded to the current collector 12 is referred to as a short-side region R2. The long-side regions R1 and the short-side regions R2 are indicated by stippling in FIG. 4. Portions where the long-side seal components 143 and the short-side seal components 144 overlap with each other are included in the long-side regions R1 or the short-side regions R2. Thus, the overlapping portions of the long-side seal components 143 and the short-side seal components 144 are welded to each other by the welding step. The long-side regions R1 and the short-side regions R2 overlap with each other at the opposite end portions 143a of the long-side seal components 143 in the first direction Y and the opposite end portions 144a of the short-side seal components 144 in the second direction Z.

The welding step is performed multiple times between the opposite end portions of each seal component 140 in the extending direction of the corresponding side 12f. In the present embodiment, when the long-side seal components 143 are welded to the current collector 12, the welding step is performed three times between the opposite end portions 143a of the long-side seal components 143 in the first direction Y. When the short-side seal components 144 are welded to the current collector 12, the welding step is performed two times between the opposite end portions 144a of the short-side seal components 144 in the second direction Z.

In the second and subsequent welding steps, the target section 145 is a part of the seal component 140 that is at least partially shifted from the target section 145 of the previous welding step in the direction in which the sides 12f extend. In the present embodiment, in each of the second and subsequent welding steps performed when the long-side seal components 143 are welded to the current collector 12, the target sections 145 are parts of the seal components 140 that are partially shifted from the target sections 145 of the previous welding step in the first direction Y. In the second and subsequent welding steps, a part of each target section 145 in the extending direction of the side 12f overlaps with the corresponding target section 145 of the previous welding step.

The target sections 145 in the welding steps performed on the long-side seal components 143 include first target sections 145a, which are the target sections 145 in the first welding step, second target sections 145b, which are the target sections 145 in the second welding step, and third target sections 145c, which are the target section in the third welding step. Each second target section 145b is partially shifted from the corresponding first target section 145a in the first direction Y. Each third target section 145c is partially shifted from the corresponding second target section 145b in the first direction Y. A first end portion of each second target section 145b in the first direction Y overlaps with a part of the corresponding first target section 145a, and a second end portion of each second target section 145b in the first direction Y overlaps with a part of the corresponding third target section 145c.

The target sections 145 in the welding steps performed on the short-side seal components 144 include first target sections 145a, which are the target sections 145 in the first welding step, and second target sections 145b, which are the target sections 145 in the second welding step. The first target sections 145a and the second target sections 145b in the welding steps performed on the short-side seal components 144 are not shown in FIG. 4. Also, in the welding steps for the short-side seal components 144, a part of each target section 145 overlaps with the corresponding target section 145 of the previous welding step, similarly to the welding step for the long-side seal components 143. In the welding steps for the short-side seal components 144, the end portions of each first target section 145a and parts of the second target sections 145b in the second direction Z overlap with each other.

By performing the welding steps on the long-side seal components 143 and the welding steps on the short-side seal components 144, the electrode 11 in which the seal components 140 are integrated with the current collector 12 is produced. In this manner, the welding of the seal components 140 to the current collector 12 by the jigs 60 is repeated to sequentially produce the electrodes 11, in which the seal components 140 are integrated with the current collectors 12.

### Details of Welding Step for Long-Side Seal Components

Next, the welding step for the long-side seal components 143 will be described. A detailed description of the welding step for the short-side seal components 144 is omitted. In the following description of the welding step for the long-side seal components 143, by substituting “second direction Z” for “first direction Y” and omitting the welding step for the third target sections 145c, the description can be applied to the welding step for the short-side seal components 144.

As shown in FIG. 6, in the welding step for the first target sections 145a, the electrode 11 is moved relative to the jigs 60 to a position where the heater portions 61 respectively face the first target sections 145a in the thickness direction of the current collector 12. At this time, the electrode 11 is disposed such that the first direction Y agrees with the longitudinal direction of the jigs 60. The two jigs 60 are disposed so as to sandwich the current collector 12 in the thickness direction. The welding step is performed on the seal components 140 disposed on the opposite surfaces of the current collector 12. As the base portions 63 are moved in the thickness direction of the current collector 12 from the positions where the heater portions 61 face the first target sections 145a, the jigs 60 are moved to approach the first target sections 145a.

When the heater portions 61 move to positions at which the heater portions 61 come into contact with the first target sections 145a of the seal components 140, the movement of the base portions 63 in the thickness direction of the current collector 12 is stopped, so that the movement of the jigs 60 is stopped. At this time, the heater portions 61 are pressed against the main bodies 140a of the first seal component 141 and the second seal component 142. The rubber portions 62 may be compressively deformed as the heater portions 61 are pressed against the seal components 140. In the present embodiment, the two jigs 60 are moved to approach each other, so that the seal components 140 and the current collector 12 are sandwiched between the jigs 60. In this state, the heater portions 61 of the jigs 60 are pressed against the seal components 140 and the exposed portions. Therefore, each of the two jigs 60 is also used as a support member that receives the pressing force of the other jig 60.

The heater portions 61 generate heat while being pressed against the first target sections 145a. The heating by the heater portions 61 may be started before or after the heater portions 61 are pressed against the seal components 140. The heater portions 61 heat the first target sections 145a while being in planar contact with the first target sections 145a. When the first target sections 145a are heated by the heater portions 61, the corner portions 64a of the jigs 60 also come into contact with the seal components 140.

The heater portions 61 stop generating heat while still being pressed against the first target sections 145a. When a specified time elapses while the heater portions 61 are pressed against the first target sections 145a, the seal components 140 are cooled, so that the seal components 140 are welded to the current collector 12. In the welding step, the welding parts 41a are formed, at which the first target sections 145a are welded to the surfaces of the current collector 12, at the boundary between the seal components 140 and the current collector 12 in the first target sections 145a.

When the welding parts 41a are formed in the first target sections 145a, the welding step for the first target sections 145a by the jigs 60 is finished. The welding step for the first target sections 145a is finished by moving the jigs 60 in the thickness direction of the current collector 12 so that the heater portions 61 are separated from the seal components 140.

As shown in FIG. 7, after the welding step for the first target sections 145a is performed, the welding step for the second target sections 145b is performed. In the welding step for the second target sections 145b, the electrode 11 is moved in the first direction Y relative to the jigs 60 to a position where the heater portions 61 face the second target sections 145b. As the base portions 63 are moved in the thickness direction of the current collector 12 from the positions where the heater portions 61 face the second target sections 145b, the jigs 60 are moved to approach the second target sections 145b.

When the heater portions 61 move to positions at which the heater portions 61 come into contact with the second target sections 145b of the seal components 140, the second target sections 145b are welded to the current collector 12 in the same manner as when the first target sections 145a is welded. At this time, end portions of the second target sections 145b in the first direction Y overlap with parts of the first target sections 145a. That is, the heater portions 61 press the second target sections 145b and parts of the first target sections 145a. Therefore, an end portion of each second target section 145b in the first direction Y overlaps with a part of the welding part 41a formed in the corresponding first target section 145a. In the welding step, the welding parts 41a are formed, at which the second target sections 145b are welded to the surfaces of the current collector 12, at the boundary between the seal components 140 and the current collector 12 in the second target sections 145b. When the welding parts 41a are formed in the second target sections 145b, the welding step for the second target sections 145b by the jigs 60 is finished.

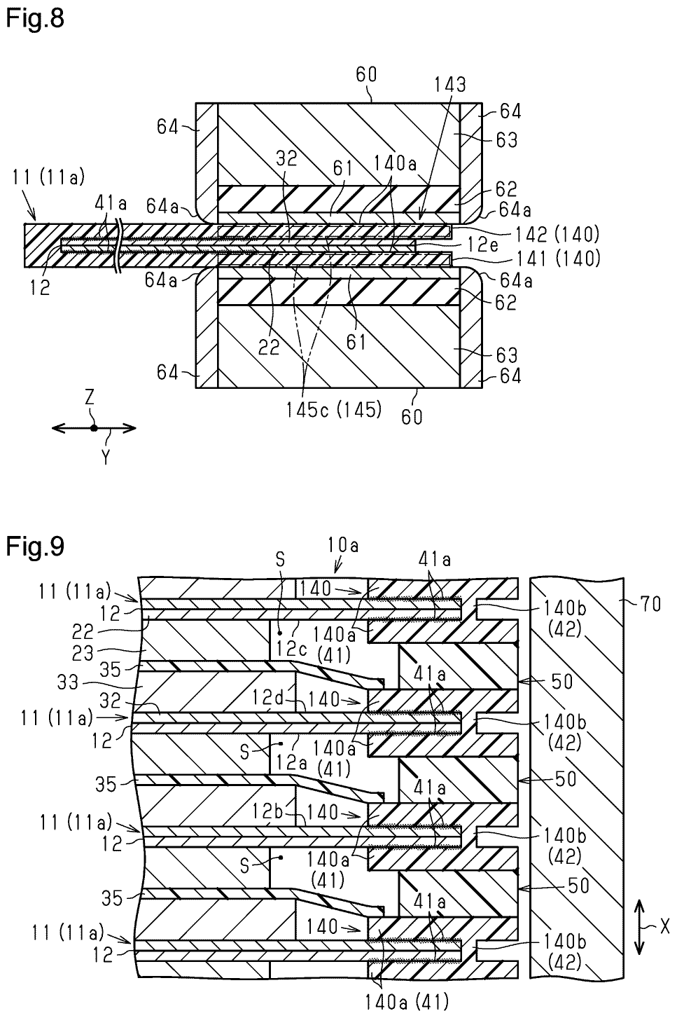

As shown in FIG. 8, after the welding step for the second target sections 145b is performed, the welding step for the third target sections 145c is performed. In the welding step for the third target sections 145c, the electrode 11 is moved in the first direction Y relative to the jigs 60 to a position where the heater portions 61 face the third target sections 145c. As the base portions 63 are moved in the thickness direction of the current collector 12 from the positions where the heater portions 61 face the third target sections 145c, the jigs 60 are moved to approach the third target sections 145c.

When the heater portions 61 move to a position at which the heater portions 61 come into contact with the third target sections 145c of the seal components 140, the third target sections 145c are welded to the current collector 12 in the same manner as when the first target sections 145a and the second target sections 145b are welded to the current collector 12. At this time, end portions of the third target sections 145c in the first direction Y overlap with parts of the second target sections 145b. That is, the heater portions 61 press the third target sections 145c and parts of the second target sections 145b. Therefore, an end portion of each third target section 145c in the first direction Y overlaps with a part of the welding part 41a formed in the corresponding second target section 145b. In the welding step, the welding parts 41a are formed, at which the third target sections 145c are welded to the surfaces of the current collector 12, at the boundary between the seal components 140 and the current collector 12 in the third target sections 145c. When the welding parts 41a are formed in the third target sections 145c, the welding step for the third target sections 145c by the jigs 60 is finished.

Electrode after Welding Step

As shown in FIGS. 5 and 9, when the seal components 140 are welded to the current collector 12 by performing the welding step for the long-side seal components 143 and the welding step for the short-side seal components 144, the electrode 11a integrated with the seal component 140 is obtained. The main bodies 140a of the seal components 140 welded to the surfaces of the current collector 12 after the welding steps correspond to the first seal sections 41 of the seal member 40. The welded portions of the protruding portions 140b of the first seal components 141 and the second seal components 142 after the welding step correspond to the second seal section 42 of the seal members 40.

### Method for Producing Power Storage Device

As shown in FIG. 9, the electrodes 11a integrated with the seal components 140, the separators 35, and the spacers 50 are sequentially stacked in the stacking direction X. A spacer 50 is interposed between the seal component 140 integrated with one of any two of the electrodes 11a adjacent to each other in the stacking direction X and the seal component 140 integrated with the other electrode 11a.

Next, the seal components 140 and the spacers 50 are welded together. The seal components 140 and the spacers 50 may be welded together by non-contact welding using a welding jig 70, for example. The welding jig 70 is, for example, an infrared heater. Parts of the protruding portions 140b of the seal components 140 and parts of the spacers 50 are heated and melted by the infrared rays irradiated from the welding jig 70. As a result, parts of the protruding portions 140b and parts of the spacer portions 50 are welded together to be integrated. A region of a specified width from the edge of the protruding portion 140b of each seal component 140 is welded to a region of the specified width from the edge of the corresponding spacer 50. That is, the sealing portion 16 is formed by welding the outer end faces of the stacked plastic portions formed by stacking the multiple seal components 140 and the multiple spacers 50.

As a result, as shown in FIG. 2, the seal members 40 are formed, and the sealing portion 16 is formed by the second seal sections 42 and the spacers 50, which are integrated.

### Experimental Results on Relationship Between Dimensions of Target Sections and Occurrence of Deformation in Current Collectors

An experiment was conducted to examine the relationship between the dimensions of the target sections 145, which were the areas to be welded in the seal components 140, and the occurrence of deformation in the current collectors 12. The positive electrode current collectors 22 of the current collectors 12 used in this experiment were aluminum foils, and the negative electrode current collectors 32 were copper foils. In each of the current collectors 12 used in the experiment, the positive electrode current collector 22 and the negative electrode current collector 32 were bonded to each other with a conductive adhesive in which carbon was mixed as a conductive aid in a polyolefin-based adhesive. The current collectors 12 had a thickness of 65 μm. The seal components 140 used in the experiment were made of acid-modified low-density polyethylene and had a thickness of 120 μm.

In the experiment, the seal components 140 were welded to the opposite surfaces of the current collector 12 by an impulse sealer under the conditions that the welding temperature was 195° C., and the surface pressure during welding was higher than or equal to 0.7 MPa. In this experiment, when the dimension of the target sections 145, to which the seal components 140 were welded, was less than or equal to the 720 mm, the current collector 12 was not deformed by the welding of the seal components 140 to the current collector 12.

### Operation

Operation of the present embodiment will now be described.

When the seal components 140 are welded to the current collector 12, the jigs 60 heat the seal components 140 while being in planar contact with the seal components 140 and pressing the target sections 145 against the current collector 12. The seal components 140 thermally expand by receiving heat from the jigs 60. At this time, the greater the dimension of the target sections 145, which are heated by the jigs 60, the greater the amount of thermal expansion of the seal components 140 becomes. When the heating of the seal components 140 by the jigs 60 is finished, the seal components 140 are cooled and thus thermally shrunk. The greater the amount of thermal expansion of the seal components 140, the greater the amount of thermal shrinkage of the seal components 140.

If the target sections 145 were the entire portion between the opposite end portions 143a of each seal component 140 in the extending direction of the long sides 12h, the dimension of the target sections 145 in the extending direction of the sides 12f would be the same as the dimension of the long sides 12h. If the target sections 145 were the entire portion between the opposite end portions 144a of each seal component 140 in the extending direction of the short sides 12g, the dimension of the target sections 145 in the extending direction of the sides 12f would be the same as the dimension of the short sides 12g. In contrast, the dimension of the target sections 145 of the present embodiment in the direction in which the sides 12f extend is smaller than the side 12f. Therefore, as compared to a case in which the dimension of the target sections 145 in the extending direction of the sides 12f is the same as the dimension of the sides 12f, the dimension of the target sections 145 is reduced, and thus the amount of thermal expansion of the seal components 140 is reduced.

### Advantages

The above-described embodiment has the following advantages.
(1) Each seal component 140 includes the target section 145, and the dimension of the target section 145 in the extending direction of the side 12f is smaller than the side 12f. The welding step is executed to press the target section 145 against the current collector 12 and heats the target section 145 with the jig 60 while causing the jig 60 to be in planar contact with the target section 145. This process forms the welding parts 41a, in which the target sections 145 are welded to the surfaces of the current collector 12. Therefore, as compared to a case in which the dimension of the target sections 145 in the extending direction of the sides 12f is the same as the dimension of the sides 12f, the dimension of the target sections 145 is reduced, and thus the amount of thermal expansion of the seal components 140 is reduced. As the amount of thermal expansion of the seal components 140 decreases, the amount of thermal shrinkage of the seal components 140 decreases. This reduces the shrinkage force transmitted from the seal components 140 to the current collector 12 due to thermal shrinkage of the seal components 140. Accordingly, the deformation of the current collector 12 that occurs when the seal components 140 is welded to the current collector 12 is reduced.

(2) In the disposing step, the seal components 140 are disposed on the opposite surfaces of the current collector 12. The welding step is performed on the seal components 140 disposed on the opposite surfaces of the current collector 12. This reduces deformation of the current collector 12 that occurs when the seal components 140 are welded to the opposite surfaces of the current collector 12.

(3) In the second and subsequent welding steps, a part of each target section 145 in the extending direction of the side 12f overlaps with the corresponding target section 145 of the previous welding step. Therefore, when the welding step is performed, even if the relative position of the target sections 145 with respect to the jigs 60 in the extending direction of the side 12f is displaced from the intended position, only the extent of overlap between the target sections 145 and the target sections 145 of the previous welding step will change with respect to the extending direction of the side 12f. Accordingly, the target sections 145 are unlikely to have parts that are not welded to the current collector 12. This reduces the occurrence of welding defects in the seal components 140 to the current collector 12.

(4) Each jig 60 includes the corner portions 64a that come into contact with the corresponding seal component 140 when the target section 145 is heated by the heater portion 61. The corner portions 64a are curved. Since the corner portions 64a are curved, it is possible to reduce the occurrence of local bulging of the seal components 140 due to the seal components 140 being pressed by the corner portions 64a when the corner portions 64a come into contact with the seal components 140. If there is localized bulging of the seal components 140, the dimensional tolerance in the stacking direction X of the power storage device 10 may be surpassed after the seal components 140 are stacked. The present embodiment prevents such deviations from the tolerance. Additionally, when the spacers 50 and the seal components 140 are stacked, such bulging of the seal components 140 may create a gap between the spacers 50 and the seal components 140. In this case, the gap formed between each spacer 50 and the corresponding seal component 140 during the formation of the sealing portion 16 may lead to defective welding between the spacer 50 and the seal component 140. The present embodiment prevents the occurrence of such welding defects.

(5) The dimension of the target sections 145 in the extending direction of the sides 12f is less than or equal to the 720 mm. Thus, the deformation of the current collector 12 that occurs when the seal components 140 are welded to the current collector 12 is further reduced.

(6) If the current collector 12 on which the seal components 140 are disposed were transported between rollers, and the seal components 140 were sequentially welded to the current collector 12 by the rollers, the welding would be performed by linear contact of the rollers. As a result, it would be difficult to expel the air that enters the welded portion of the seal components 140. Consequently, voids may form in the seal members 40. If voids formed, the adjacent internal spaces S in the stacking direction X of the power storage device 10 may be connected through the voids in the seal members 40, leading to a potential short circuit. According to the above-described embodiment, the welding step is performed by heating the target sections 145 while causing the jigs 60 to make planar contact with the target sections 145. Therefore, air that has entered the welded portions of the seal components 140 is readily expelled, and voids are less likely to form in the seal members 40. Therefore, the occurrence of short circuits caused by void formation is suppressed.

### Modifications

The above-described embodiment may be modified as follows. The above-described embodiment and the following modifications can be combined as long as the combined modifications remain technically consistent with each other.

The number of times of performing the welding step between the opposite end portions 143a of each seal component 140 in the first direction Y may be two or greater than three. The number of times of performing the welding step between the opposite end portions 144a of each seal component 140 in the second direction Z may be greater than two. The number of times of performing the welding step between the opposite end portions 143a of the seal component 140 in the first direction Y may be the same as or different from that between the opposite end portions 144a of the seal component 140 in the second direction Z.

The dimensions of the target sections 145 in the first direction Y may be different from each other in all or some of the multiple welding steps performed between the opposite end portions 143a of the seal component 140 in the first direction Y. The dimensions of the target sections 145 in the second direction Z may be different from each other in all or some of the multiple welding steps performed between the opposite end portions 144a of the seal component 140 in the second direction Z.

The dimensions of the target sections 145 in the first direction Y may be greater than 720 mm in all or some of the multiple welding steps performed between the opposite end portions 143a of the seal component 140 in the first direction Y. The dimensions of the target sections 145 in the second direction Y may be greater than 720 mm in all or some of the multiple welding steps performed between the opposite end portions 144a of the seal component 140 in the second direction Z. These modifications also reduce deformation of the current collector 12 that occurs when the seal component 140 is welded to the current collector 12, as compared to a case in which the target section 145 corresponds to the entire seal component 140 and the welding is performed in a single welding step.

The corner portions 64a are not limited to parts of the jig electrodes 64. For example, the corner portions 64a may be parts of the heater portion 61. In this case also, the corner portions 64a are located at the periphery of the heater portion 61.

The corner portions 64a do not necessarily need to be curved.

In one or more welding steps among the second and subsequent welding steps performed between the opposite end portions 143a of the seal component 140 in the first direction Y, the target section 145 does not necessarily need to overlap with the target section 145 of the previous welding step. In one or more welding steps among the second and subsequent welding steps performed between the opposite end portions 144a of the seal component 140 in the second direction Z, the target section 145 does not necessarily need to overlap with the target section 145 of the previous welding step.

Among the welding steps performed between the opposite end portions of the seal component 140 in the direction in which the side 12f extends, the target section 145 in the first welding step does not necessarily need to include the opposite end portions of the seal component 140 in the direction in which the side 12f extends. In this case, the target sections 145 in the second and subsequent welding steps include the opposite end portions of the seal component 140 in the direction in which the side 12f extends.

The welding steps for the seal component 140 disposed on the first surface 12a of the current collector 12 and the welding steps for the seal component 140 disposed on the second surface 12b of the current collector 12 may be performed at different times. In this case, after the seal component 140 is disposed on one surface of the current collector 12 in the disposing step, the welding step may be performed on the disposed seal component 140. Further, the seal components 140 may be welded to only one surface of the current collector 12 by performing the disposing step and the welding steps only on that surface of the current collector 12.

The dimension of the short sides 12g is not limited to 1.2 meters. The dimension of the long sides 12h is not limited to 1.5 meters. For example, the dimension of the short sides 12g may be less than 1 meter. In other words, the dimensions may be changed as long as at least one of the sides 12f of the current collector 12 exceeds 1 meter. The phrase “at least one of” as used in this description means “one or more” of desired options. As an example, the expression “at least one” as used in this description means “only one of the options” or “both of the two options” if the number of options is two. In another example, the phrase “at least one of” as used in this description means “only one single option” or “any combination of two or more options” if the number of options is three or more.

The shape of the current collector 12 in plan view is not limited to a rectangular shape. The current collector 12 may have any polygonal shape that has multiple sides 12f including a side 12f of more than 1 meter in plan view.

The power storage device 10 may include a binding member that binds the stacked body 10a. The binding member applies a binding load in the stacking direction X to a region in which the positive electrode active material layers 23 and the negative electrode active material layers 33 overlap with each other when the stacked body 10a is viewed in the stacking direction X. The binding member may include, for example, binding plates disposed at the opposite ends of the stacked body 10a in the stacking direction X, and a fastening member formed of bolts and nuts for fastening the binding plates to each other. In the case of this binding member, a binding load in the stacking direction X is applied to the stacked body 10a as a result of the binding plates being urged by the fastening members in directions approaching each other.

The heater portion 61 may be a device separate from the jig 60. In this case, the jig 60 does not need to include the heater portion 61. The heater portion 61 may be a non-contact type heating device, for example, an infrared heater, that heats the target sections 145 without contacting the target sections 145. The heating of the target sections 145 by the heating devices (heater portions 61) separate from the jigs 60 may be started at the same time as the target sections 145 are pressed by the jigs 60, or before or after the pressing action.

In each welding step, the jigs 60 may sequentially press only the target section 145, or may press a wider region including at least the target section 145. For example, the parts corresponding to the target sections 145 may be sequentially heated while the jigs 60 press the entire seal component 140 along one side 12f. In this case, the heater portions 61 separate from the jigs 60 may be moved, or the direction of heat radiation from the heater portions 61 may be changed. Alternatively, each heater portion 61 may include multiple divided heating sections, and the regions to be heated may be sequentially changed by switching the heating section that performs heating.

### Clauses

Technical concepts obtained from the above-described embodiment and the modifications will now be described.
[1] A method for producing an electrode, the electrode including a current collector having a polygonal shape with at least one side exceeding 1 meter in plan view; an active material layer provided on a surface of the current collector; and at least one seal component welded to the surface of the current collector, the method including:
   a disposing step that disposes the seal component on the surface of the current collector along the side; and
   a welding step that presses a target section of the seal component against the current collector and heats the target section while causing a jig to be in planar contact with the target section, thereby forming a welding part in which the target section is welded to the surface of the current collector, a dimension of the target section in a direction in which the side extends being smaller than the side, where
   the welding step is performed multiple times between opposite end portions of the seal component in the extending direction of the side, and
   in the second and subsequent welding steps, the target section is a part of the seal component that is at least partially shifted from a target section of the previous welding step in the extending direction of the side.
[2] The method for producing the electrode according to clause 1, where
   in the disposing step, the seal component is disposed on each of opposite surfaces of the current collector, and
   the welding step is performed on the seal components disposed on the opposite surfaces of the current collector.
[3] The method for producing the electrode according to clause 1 or 2, where, in the second or subsequent welding steps, a part of the target section in the extending direction of the side overlaps with the target section of the previous welding step.
[4] The method for producing the electrode according to any one of clauses 1 to 3, where
   the jig includes:
      a heater portion that heats the target section while being in planar contact with the target section; and
      a corner portion that is located at a periphery of the heater portion and comes into contact with the seal component when the target section is heated by the heater portion, and
   the corner portion is curved.
[5] The method for producing the electrode according to any one of clauses 1 to 4, where a dimension of the target section in the extending direction of the side is less than or equal to 720 mm.

### REFERENCE SIGNS LIST

L) Dimension; Y) First Direction; Z) Second Direction; 11, 11a) Electrodes; 12) Current Collector; 12a) First Surface; 12b) Second Surface; 12f) Sides; 23) Positive Electrode Active Material Layer; 33) Negative Electrode Active Material Layer; 41a) Welding Part; 60) Jig; 61) Heater Portion; 64a) Corner Portion; 140) Seal Component; 143a, 144a) End Portions; 145) Target Section

1. A method for producing an electrode, the electrode including a current collector having a polygonal shape with at least one side exceeding 1 meter in plan view; an active material layer provided on a surface of the current collector; and at least one seal component welded to the surface of the current collector, the method comprising:
a disposing step that disposes the seal component on the surface of the current collector along the side; and
a welding step that presses a target section of the seal component against the current collector and heats the target section while causing a jig to be in planar contact with the target section, thereby forming a welding part in which the target section is welded to the surface of the current collector, a dimension of the target section in a direction in which the side extends being smaller than the side, wherein
the welding step is performed multiple times between opposite end portions of the seal component in the extending direction of the side, and
in the second and subsequent welding steps, the target section is a part of the seal component that is at least partially shifted from a target section of the previous welding step in the extending direction of the side.

2. The method for producing the electrode according to claim 1, wherein
in the disposing step, the seal component is disposed on each of opposite surfaces of the current collector, and
the welding step is performed on the seal components disposed on the opposite surfaces of the current collector.

3. The method for producing the electrode according to claim 1, wherein, in the second or subsequent welding steps, a part of the target section in the extending direction of the side overlaps with the target section of the previous welding step.

4. The method for producing the electrode according to claim 1, wherein
the jig includes:
a heater portion that heats the target section while being in planar contact with the target section; and
a corner portion that is located at a periphery of the heater portion and comes into contact with the seal component when the target section is heated by the heater portion, and
the corner portion is curved.

5. The method for producing the electrode according to claim 1, wherein a dimension of the target section in the extending direction of the side is less than or equal to 720 mm.
